(19) United States
(12) Patent Application Publication
(10) Pub. No.: US 2013/0237694 A1
(43) Pub. Date: Sep. 12, 2013

(54) LIGNIN-BASED CONCRETE ADMIXTURES

(71) Applicant: Georgius Abidal Adam, Edensor Park (AU)

(72) Inventor: Georgius Abidal Adam, Edensor Park (AU)

(73) Assignee: EMPIRE TECHNOLOGY DEVELOPMENT LLC, Wilmington, DE (US)

(21) Appl. No.: 13/698,904

(22) PCT Filed: Mar. 7, 2012
(86) PCT No.: PCT/US12/28026

§ 371 Date: Nov. 19, 2012

(51) Int. Cl. C08H 7/00

(52) U.S. Cl. CPC C08H 6/00
USPC 530/501

(57) ABSTRACT

Methods for converting waste streams from the wood pulping industry to high-value concrete admixtures are described. For example, isolated lignin and lingnosulfonate or waste streams containing lignin and lingnosulfonate can be directly converted to the concrete admixtures, or they may be first converted to their methylol derivatives and treated with further reagents to produce the concrete admixtures.

### BACKGROUND

Lignin, which represents 15-35% of wood, is the most abundant renewable organic material on the earth. The pulping industry separates cellulose from the wood composition resulting in lignin and he In e ell U lose waste by-products known as black liquor and spent pulp liquor. In the sulphite process, the main by-product contained in the spent pulp liquor is lignosulphonate. With each ton of pulping products producing 330-540 Kg of lignosulphonate, the global annual production capacity of lignosulphonate is about 1.8-2.0 million tons. Most of the lignosulphonate (66%) produced in pulping industries is burned as fuel and 34% is treated and disposed. Using this waste stream as a fuel source is inefficient, and releases large amounts of pollutants such as SO₂. Simple disposing of lignin, on the other hand, incurs a significant cost to the pulping industry.

Currently, lignosulphanate is used as a plasticizer or water reducer for ready-mix concrete. It is cheap, but of poor quality and not suitable as a plasticiser in hot weather conditions, for high-rise buildings, or for self-leveling and self-compacting concrete. These applications require hyper plasticisers and super plasticisers, which can reduce water content by 30-40%, and lead to remarkable improvements in the physical, mechanical and application properties of the concrete. Synthetic super plasticisers based on polycarboxylate ethers have super fluidity convenient for self-leveling, high compressive strength, and high water reducing efficiency, but are orders of magnitude more expensive than lignosulphonate.

### SUMMARY

This disclosure is not limited to the particular systems, devices and methods described, as these may vary. The terminology used in the description is for the purpose of describing the particular versions or embodiments only, and is not intended to limit the scope. While various compositions and methods are described in terms of “comprising” various components or steps (interpreted as meaning “including, but not limited to”), the compositions and methods can also “consist essentially of” or “consist of” the various components and steps, and such terminology should be interpreted as defining essentially closed-member groups,

Methods describe novel and simple processes comprising, among other things, the production of lignin-based concrete admixtures. In some embodiments, methods of fabricating a carboxylate super plasticizer from black liquor or spent liquor are described. The methods described herein may allow facile production of :high-value products from waste stream from the pulping industry.

In an embodiment, a method of preparing a lignosulphonate methylol may comprise contacting lignosulphonate with an aldehyde compound to produce the lignosulphonate methylol. In such embodiments, the source of the lignosulphonate may be sulphonated black liquor or spent pulp liquor.

In an embodiment, a method of preparing a lignin methylol may comprise contacting lignin with an aldehyde compound at a pH of about 9 to about 10 to produce the lignin methylol. In such embodiments, the source of the lignin may be black liquor,

In an embodiment, a method of preparing lignin methylol or lignosulphonate methylol from solid lignin or solid lignosulphonate may comprise contacting lignin or lignosulphonate with an aldehyde compound to produce lignin methylol or lignosulphonate methylol. In such embodiments, the source of the lignosulphonate may be dried or dewatered black liquor or spent pulp liquor,

In an embodiment, a method of preparing a concrete additive may comprise contacting lignin methylol or lignosulphonate methylol with a reagent to produce the concrete additive. In some embodiments, the reagent may comprise a carboxylic acid compound and the concrete additive may be a lignin carboxylate compound or a lignosulphonate carboxylate compound.

In an embodiment, a method of preparing a concrete additive may comprise contacting lignin with a reagent to produce the concrete additive. In some embodiments, the reagent may comprise a carboxylic acid compound and the concrete additive may be a lignin carboxylate compound or a lignosulphonate carboxylate compound.

In an embodiment, a method of preparing lignocarboxylate or lignosulphonate carboxylate may comprise contacting lignin or lignosulphonate with carbon dioxide to produce lignocarboxylate or lignosulphonate carboxylate.

In an embodiment, a concrete additive may comprise a lignophosphate compound, a lignosulphonate phosphate compound, a limoethanolamine compound, a lignosulphonate ethanolamine compound, a lignopolyhydroxycarboxy late compound, a lignosulphonate polyhydroxycarboxylate compound, a lignopolycarboxylate compound, a lignosulphonate polycarboxylate compound, a lignohydroxycarboxylate compound, or a lignosulphonate hydroxycarboxylate compound.

In some embodiments, a water-based resin may comprise a lignoepoxide compound or a lignosulphonate epoxide compound. In other embodiments, a polyurethane product may comprise a lignourethane compound or a lignosulphonate urethane compound. In further embodiments, a corrosion inhibitor, epoxy hardener, or a base for a hydrogel may comprise a lignoamine compound or a lignosulphonate amine compound.

### DETAILED DESCRIPTION

Described herein are methods for producing lignin-based concrete admixtures. In some embodiments, lignin-bed starting material may be sourced from waste pulp streams including black liquor and spent pulp liquor. In some embodiments, lignin-based starting material may be converted to methylols.

In an embodiment, a method of preparing a lignosulphonate methylol may comprise contacting lignosulphonate with an aldehyde compound to produce the lignosulphonate methylol. The lignosulphonate may comprise spent pulp liquor, sulphonated black liquor, or a combination thereof The solid content of the spent pulp liquor or sulphonated black liquor may be adjusted to about 40% to about 70% by weight, to about 45% to about 65% by weight, or to about 50% to about 60% by weight prior to contacting the lignosulphonate with the aldehyde compound. Specific examples of solid content include about 40%, about 45%, about 50%, about 55%, about 60%, about 65%, about 70%, and ranges between any two of these values (for example, from about 50% to about 65%). The net active weight of lignin in the black liquor may be determined from the total organic content as measured by thermal analysis of a sample of the black liquor dried at about 100° C. for about 3 hours. The net active content ratio of the lignosulphonate to the aldehyde compound may be about 1:1 to about 2:0:1, about 1:1 to about 15:1, about 2:1 to about 15:1, about 2:1 to about 10:1, about 2:1 to about 7.5:1, or about 2,5:1 to about 5:1. Specific examples of ratios include about 1:1, about 2:1, about 2.5:1, about 5:1, about 7.5:1, about 10:1, about 12.5:1, about 15:1, about 17.5:1, about 20:1, and ranges between any two of these values (for example, from about 101 to about 17,5:1), in some embodiments, the aldehyde compound may be formaldehyde, paraformaldehyde, or thoxane.

In some embodiments, the lignosulphonate may be contacted with the aldehyde compound at a pH of about 8 to about 12, at a pH of about 9 to about 11, or at a pH of about: 9,5 to about 10.5, in some embodiments, the lignosulphonate may be contacted with the aldehyde compound at a pH of about 9 to about 10. Specific examples of pH include about 8, about 8.5, about 9, about 9,5, about 10, about 10,5. about 11, about 11.5, about 12, and ranges between any two of these values (for example, from about 10,5 to about 12). The lignosulphonate may be contacted with the aldehyde compound at a temperature of about 50° C. to about 85° C., about 55° C. to about 0° C. about 60° C. to about 75° C. or about 65° C. to about 70° C. In some embodiments, the lignosulphonate may be contacted with the aldehyde compound at a temperature of about 65° C. to about 70° C. Specific examples of temperatures include about 50° C., about 55° C. about 60° C., about 65° C., about 70° C. about 75° C., about 80° C., about 85° C., and ranges between any two of these values (for example, from about 65° C. to about 80° C.). The lignosulphonate may be contacted with the aldehyde compound for about 2 to about 5 hours, about 2.5 to about 4.5 hours, or about 3 to about 4 hours. In some embodiments, the lignosulphonate may be contacted with the aldehyde compound for about 3 to about 4 hours. In some embodiments, the lignosulphonate may be contacted with the aldehyde compound for about 3 hours. Specific examples of contact time include about 2 hours, about 2.5 hours, about 3 hours, about 3.5 hours, about 4 hours, about 4.5 hours, about 5 hours, and ranges between any two of these values (for example_{:} from about 3.5 hours to about 4.5 hours). In some embodiments, higher temperatures may be synchronised with lower reaction times. In some embodiments heating for more than about 3 hours may occur with reaction temperatures below about 60° C. At higher temperatures and longer reaction, times, the methylol resins may condense and form a bulk of highly crosslinked thermoset resin.

In some embodiments, the lignos (phonate methylol may comprise lignosulphonate monomethylol, lignosulphonate dimethylol, lignosulphonate trimethylol, or lignosulphonate oligamethylol. In further embodiments, the lignosulphonate methylol may be cooled to about 0° C. to about 10° C., or to about 0° C. to about 5° C. In further embodiments, the lignosulphonate methylol may be cooled to about 0° C. to about 10° C. In some embodiments, the lignosulphonate methylol may be cooled to about 0° C. to about 5° C. Specific examples of cooled temperatures include about 0° C., about 5° C., about 10° C., and ranges between any two of these values (for example, from about 5° C. to about 10° C).

The cooled lignosulphonate methylol may be neutralized with a pre-cooled acid, which may be at about -10° C. to about 0° C., and may be about 2% to about 15% or about 5% to about 10% acid, by weight. in some embodiments, the pre-cooled acid may be at about 0 to about 5° C. Specific cooled temperatures include about -10° C., about 0° C., about 5° C., about 10° C. and ranges between any two of these values (for example, from about 0° C. to about 5° C.). Specific concentration examples include about 2% by weight, about 5% by weight, about 7% by weight, about 10% by weight, and ranges between any two of these values for example, from about 5% to about 10%). In some embodiments, the cooled lignosulphonate methylol may be neutralized to a pH of about 6.8 to about 7.2, to a pH of about 6.9 to about 7.1, or to a pH of about 7. In some embodiments, the cooled lignosulphonate methylol may be neutralized to a pH of about T In some embodiments, the pre-cooled acid may be phosphoric acid, paratoluenesulphonic acid, hydroxy acetic acid, ilduconic acid, a hydroxypolycarboxylic acid, or a combination thereof.

In some embodiments, the neutralized, cooled, lignosulphonate methylol may be isolated, and the separated lignosulphonate methylol may be dissolved in at least one alcohol. In some embodiments, the alcohol may be selected from ethanol, methylated spirits, and isobutanal. In further embodiments, the lignosulphonate methylol may be dried. In some embodiments, the alcohol may be evaporated under reduced pressure to produce the lignosulphonate methylol as a solid residue, or semi-solid viscous product, or viscous product. In some embodiments, the lignosulphonate methylol may be dried with molecular sieves.

In another embodiment, a method of preparing a lignin methylol may comprise contacting lignin with an aldehyde compound at a pH of about 9 to about 10 to produce the lignin methylol. The lignin may comprise black liquor, and the solid content of the black liquor may be adjusted to about 40% to about 70% by weight, to about 45% to about 65% by weight, or to about 50% to about 60% by weight prior to contacting the lignin with the aldehyde compound. Specific examples of solid content include about 40%, about 45%, about 50%. about 5,5%, about 60%, about 65%, about 70%, and ranges between any two of these values (for example, from about 45% to about 60%). The net weight active content ratio of the lignin to the aldehyde compound may he about 1:1 to about 20:1. In some embodiments, the net active content ratio of the lignin to the aldehyde compound may be about 1:1 to about 20:1, about 1:1 to about 15:1, about 2:1 to about 15:1, about 2:1 to about 10:1, about 2:1 to about 7.5:1, or about 2.5:1 to about 5:1. Specific examples of ratios include about 1:1, about 2:1, about. 2,5:1, about 5:1, about. 7.5:1, about 10:1, about 12.5:1, about 15:1, about 17.5:1, about 20:1, and ranges between any two of these values (for example, from about 12.5:1 to about 17.5:0. In some embodiments, the aldehyde compound may be formaldehyde, paraformaldehyde, or trioxane,.

In some embodiments, the lignin may be contacted with the aldehyde compound at as temperature of about 50° C. to about 85° C., about 55° C. to about 80° C., about 60° C. to about 75° C., or about 65° C. to about 70° C. In some embodiments, the lignin may be contacted with the aldehyde compound at a temperature of about 65° C. to about 70° C. Specific examples of temperatures include about 50° C., about 55° C., about 60° C., about 65° C., about. 70° C. about. 75° C. about 80° C., about 85° C., and ranges between any two of these values (for example, from about 55° C. to about 70° C.). The Irvin may be contacted with the aldehyde compound for about 2 to about 5 hours, about 2.5 to about 4.5 hours, or about 3 to about 4 hours. In some embodiments, the lignin may be contacted with the aldehyde compound for about 3 to about 4 hours. In some embodiments, the lignin may be contacted with the aldehyde compound for about 3 hours. Specific examples of contact tune include about 2 hours about 2.5 hours, about 3 hours, about 3.5 hours, about 4 hours, about 4.5 hours, about 5 hours, and ranges between any two of these values (for example, from about 3.5 hours to about 4.5 hours). In some embodiments, higher temperatures may be synchronised with lower reaction times. In some embodiments, heating for more than about 3 hours may occur with reaction temperatures below about 60° C. At higher temperatures and longer reaction times, the methylol resins may condense and form a bulk of highly cross linked thermoset resin. In some embodiments, the lignin may be contacted with the aldehyde compound at a pH of about 10. Specific examples of pH include about 8, about 8.5, about 9, about 9.5, about 10, about 10.5, and ranges between any two of these values for example, from about 9 to about 10).

In some embodiments, the lignin methylol may comprise lignin monomethylol, lignin dimethylol, lignin trimethylol, or lignin oligomethylol. In further embodiments, the lignin methylol may be cooled to about 0° C. to about 10° C. or to about 0° C. to about 5° C. In further embodiments, the lignin methylol may be cooled to about 0° C. to about 10° C. In some embodiments, the lignin methylol may be cooled to about 0° C. to about 5° C. Specific examples of cooled temperatures include about 0° C., about 5° C. about 10° C., about 15° C. and ranges between any two of these values (for example, from about 5° C. to about 10° C.). The cooled lignin methylol may be neutralized with a pre-cooled acid, which may be at about −10° C. to about 10° C., and may be about 2% to about 10% or about 5% to about 10% acid, by weight. in some embodiments, the pre-cooled acid may be at about ^{it} to about 5° C. Specific pre-cooled temperatures include about -10° C., about 0° C., about 5° C., about 10° C., and ranges between any two of these values (for example, from about 0° C. to about 5° C.). Specific concentration examples include about 2% by weight, about 5% by weight, about 7% by weight. about 10% by weight, and ranges between any two of these values (for example, from about 5% to about 7%). in some embodiments, the cooled lignin methylol may be neutralized to a pH of about 6.8 to about 7.2, to a pH of about 6.9 to about 7.1, or to a pH of about 7, in some embodiments, the cooled lignin methylol may be neutralized to a pH of about 7. In some embodiments, the pre-cooled acid may be phosphoric acid.

In some embodiments, the neutralized, cooled, lignin methylol may be isolated, and the separated lignin methylol may be dissolved in at least one alcohol. In some embodiments, the alcohol may be selected from ethanol, methylated spirits and isobutanol. In further embodiments, the lignin methylol may be dried. In some embodiments, the alcohol may be evaporated under reduced pressure to produce the lignin methylol as a solid residue, or semi-solid viscous product, or viscous product. In some embodiments, the lignosulphonate methylol may be dried with molecular sieves.

In an additional embodiment, a method of preparing lignin methylol or lignosulphonate methylol from solid lignin or solid lignosulphonate may comprise dissolving the lignin or lignosulphonate and contacting the dissolved lignin or lignosulphonate with an aldehyde compound to produce the lignin methylol or lignosulphonate methylol. The lignin or lignosulphonate may comprise spent pulp liquor_{;} sulphonated black liquor, black liquor, or a combination thereof In some embodiments, the lignin or lignosulphonate may be dissolved in a base solution, in these embodiments, the base solution may be about 10% to about 20% by weight, about 12,5% to about 15% by weight sodium hydroxide or calcium hydroxide. The solid content of the spent pulp liquor or sulphonated black liquor may be adjusted to about 40% to about 70% by weight, to about 45% to about 65% by weight, or to about 50% to about 60% by weight prior to contacting the lignosulphonate with the aldehyde compound. Specific examples of solid content include about 40%, about 45%, about 50%, about 55%, about 60%, about 65%, about 70%, and ranges between any two of these values (for example, from about, 55% to about 65%). In some embodiments, the net weight active content ratio of the lignin or ihmosulphonate to the aldehyde compound may be about 1:1 to about 20:1. In some embodiments, the net active content ratio of the lignin or lignosulphonate to the aldehyde compound may be about 1:1 to about 20:1, about 1:1 to about 1511, about 2:1 to about 15:1, about 2:1 to about 10:1, about 2;1 to about 7.5:1, or about 15:1 to about 5:1. Specific examples of ratios include about 1:1, about 2:1, about 25:1, about 5,1., about 7.5:1, about 10:1, about 125:1, about 15:1, about. 175:1, about 20:1, and ranges between any two of these values (for example, from about 2:1 to about 7.5:1). in sonic embodiments, the aldehyde compound may be formaldehyde.

In some embodiments, the lignin or lignosulphonate may be contacted with the aldehyde compound at a pH of about 9 to about 10. In some embodiments, the lignin or lignosulphonate may be contacted with the aldehyde compound at a pH of about 10, Specific examples of include about 8, about 8,5, about 9, about 95, about 1.0, about 10,5 and ranges between any two of these values (for example, from about 9 to about 10). The lignin or lignosulphonate may be contacted with the aldehyde compound at a temperature of about 50° C. to about 85° C., about 55° C. to about 80° C. about 60° C. to about 75° C., or about 65° C. to about 70° C. In some embodiments, the liunin or lignosulphonate may be contacted with the aldehyde compound at a temperature of about 65° C. to about 70° C. Specific examples of temperatures include about 50° C., about 55° C., about 60° C. about 65° C., about 70° C., about 75° C., about 80° C., about 85° C., and ranges between any two of these values (for example, from about 55° C. to about 80T). The lignin or limosulphonate may be contacted with the aldehyde compound fur about 2 to about 5 hours, about 2.5 to about 4.5 hours, or about 3 to about 4 hours, in some embodiments, the lignin or lignosulphonate may be contacted with the aldehyde compound for about 3 to about 4 hours. In some embodiments, the lignin or lignosulphonate may be contacted with the aldehyde compound for about 3 hours. Specific examples of contact time include about 2 hours, about 2.5 hours, about 3 hours, about 3.5 hours, about 4 hours, about 4.5 hours about 5 hours, and ranges between any two of these values (for example, from about 3,5 hours to about 4.5 hours). In embodiments, higher temperatures may be synchronised with lower reaction times. In some embodiments, heating for more than about 3 hours may occur with reaction temperatures below about 60° C. At higher temperatures and longer reaction times, the methylol resins may condense and form a bulk of highly crosslinked thermoset resin.

In some embodiments, the lignosulphonate methylol may comprise lignosulphonate monomethylol, lignosulphonate ditnethylol, lignosulphonate trimethylol, or lignosulphonate oligomethylol, and the lignin methylol may be lignin monomethylol, lignin dimethylol, lignin trimethylol, or lignin oligomethytol. In further embodiments, the methylol or lignosulphonate methylol may be cooled to about 0° C. to about 1.0° C. in further embodiments, the lignin methylol or lignosulphonate methylol may be cooled to about 0° C. to about 15° C., to about 0° C. to about 10° C. or to about 0° C. to about 5° C., in some embodiments, the lignin methylol or lignosulphonate methylol may be cooled to about 0° C. to about 5° C. Specific examples of cooled temperatures include about 0° C., about 5° C., about 0° C. about 1.5° C., and ranges between any two of these values (for example, from about 5° C. to about 10° C.). The cooled lignin methylol or lignosulphonate methylol may be neutralized with a pre-cooled acid, which may be at about 0° C. to about 1 5° C. or at about 0° C. to about 10° C., and may be about 2% to about IS% or about 5% to about 10% acid, by weight. In some embodiments, the pre-cooled acid may be at about 0 to about 5° C. Specific pre-cooled temperatures include about 0° C., about 5° C., about. 10° C., and ranges between any INvo of these values (for example, from about 5° C. to about 10° C.). Specific concentration examples include about 2% by weight, about 5% by weight, about 7% by weight, about 10% by weight, and ranges between any two of these values (for example, from about 5% to about 10%). In some embodiments, the cooled lignin methylol or lignosulphonate methylol may be neutralized to a pH of about 6,8 to about 7.0, to a pH of about 6.9 to about 7.0, or to a pH of about 7. In some embodiments, the cooled lignin methylol or lignosulphonate methylol may be neutralized to a pH of about 7. In some embodiments, the pre-cooled acid may be phosphoric acid.

In some embodiments, the neutralized, cooled, lignin methylol or lignosulphonate methylol may be isolated, and the separated lignin methylol or lignosulphonate methylol may be dissolved in an alcohol. In some embodiments, the alcohol may be selected from ethanol methylated spirits and isobutanol. In further embodiments, the lignin methylol or lignosulphonate methylol may be dried. In some embodiments, the alcohol may be evaporated under reduced pressure to produce the lignin methylol or lignosulphonate methylol as a solid residue, or semi-solid viscous product, or viscous product. In some embodiments, the lignin methylol or lignosulphonate methylol may be dried with molecular sieves.

In an embodiment, a method of preparing a concrete additive way comprise contacting a lignin methylol or lignosulphonate methylol with a reagent to produce the concrete additive. In some embodiments, the reagent may comprise a hydroxycarboxylic acid compound, polyhydroxycarboxylic acid, a :hydroxylamine compound, isocyanate terminated polymers, an amine compound, a phosphate compound, epichlorohydrine, or sodium bisulphite.

In some embodiments, the lignin methylol or lignosulphonate methylol may be contacted with the reagent at about 20° C. to about 60° C., at about. 25° C. to about 415° C., or at about 30° C. to about 35° C. In some embodiments, the lignin methylol or lignosulphonate methylol may be contacted with the reagent at about. 30° C. to about 35° C. In some embodiments, the lignin methylol or lignosulphonate methylol may be contacted with the reagent at about 30° C. Specific examples of temperatures include about 20° C., about 25° C., about 30° C. about 35° C., about 40° C. about 45° C., about 50° C., about 60° C., and ranges between any two of these values (for example, from about 25° C. to about 35°C.). In some embodiments, the lignin methylol or lignosulphonate methylol may be contacted with the reagent for about 1 hour to about 4 hours, about 1.5 hours to about 3 hours, or about. 2 hours. In some embodiments, the lignin methylol or lignosulphonate methylol may be contacted with the reagent for about two hours at about 30° C. Specific examples of contact time include about 1 hour, about 1.5 hours, about 2 hours, about 2.5 hours, about 3 hours, about 4 hours, about 5 hours, and ranges between any two of these values (for example, from about 1.5 hours to about 2.5 hours). Contact time may be determined by routine tests to indicate reaction completion which may be dependent on the reaction temperature and the reagent.

In further embodiments, the lignin methylol or lignosulphonate methylol and the reagent may be refluxed for about 30 minutes to about 120 minutes, about 40 minutes to about 100 minutes, or about 60 minutes to about $0 minutes. In some embodiments, the lignin methylol or lignosulphonate methylol and the reagent may be refluxed for about I hour. Specific examples of reflux time include about 1 hour, about 1.5 hours, about 2 hours, about 2.5 hours, about 3 hours, about 4 hours, about 5 hours, and ranges between any two of these values (for example, from about 3 hours to about 5 hours) In some embodiments, the reaction products may be neutralized with a basic solution. In some embodiments, the basic solution may be sodium hydroxide or calcium hydroxide at about 2% to about 20% by weight, about 5% to about 20% by weight. or about 10% to about 20% by weight.

In some embodiments where the reaii,ent comprises at least one carboxylic acid compound, the concrete additive may be a lignin carboxylate compound or a lignosulphonate carboxylate compound. In some embodiments, the carboxylic acid compound may comprise a polycarboxylic acid, a hydroxycarboxylic acid, bydroxydicarboxylic acid, or polyhydroxycarboxyhc acid. In other embodiments, the carboxylic acid compound may comprise gluconic acid, citric acid, tartaric acid, hydroxybutyric acid, hydroxyacetic acid, hydroxymalonic acid, hydroxystieeilliC acid, or hydroxyelutamic acid. In some embodiments where the reagent comprises a hydroxyamine compound, the concrete additive may comprise a lignoethanolamine compound or a lignosulphonate ethanolamine compound. In some embodiments, the hydroxylamine compound may comprise monoethanolamine diethanolamine triethanolamine, or hydroxyl antine,

In sonic embodiments where the reagent comprises an isocyante terminated polymer, the concrete additive may comprise a lignouretharte compound or a lignosulphonate urethane compound as foamed hydrogel water stop product. In some embodiments Where the reagent comprises an amine compound, the concrete additive may comprise a lignoamine compound or a lignosulphonate amine compound. In some embodiments where the reagent comprises a phosphate compound, the concrete additive may comprise a lignophosphate compound or a lignostdPhonate phosphate compound. In some embodiments Where the reagent comprises epichlorohydrine the concrete additive may comprise a water based lignoepoxy compound or a lignosulphonate epoxy compound in some embodiments where the reagent comprises sodium bisulphite, the concrete additive may comprise a lignosulphonate compound.

In another embodiment, a method of preparing a concrete additive may comprise contacting lignin with a reagent in a lignin/reagent reaction mixture to produce the concrete additive. In some embodiments, the reagent may comprise a carboxylic acid compound, a hydroxyamine compound, an isocyante terminated polymer, an amine compound, a phosphate compound, epichlorohydrine, or sodium bisulphite. In some embodiments, the lignin may be in the form of black liquor. In these embodiments, the solid content of the black liquor may be adjusted to about 40% to about 70% by weight. to about 45% to about 65% by weight, or to about 50% to about 60% by weight prior to contacting the lignin with a reagent. Specific examples of solid content include about 40%, about 45%, about 50%, about 55%, about 60%, about 65%, about 70%, and ranges between any two of these values (for example, from about 55% to about 65%).

In some embodiments, the lignin may be contacted with the reagent at about 20° C. to about 60° C., at about 25° C. to about 45° C., or at about 30° C. to about 35° C. In some embodiments, the lignin may be contacted with the reagent at about 30° C. to about 35° C. Tn some embodiments, the lignin may be contacted with the reagent at about 30° C. Specific examples of temperatures include about 20° C. about 25° C., about^{.} 30° C. about 35° C., about 40° C., about 45° C., about 50° C. about 60° C., and ranges between any two of these values (for example, from about 25° C. to about 35° C.). in some embodiments, the lignin may be contacted with the reagent for about I hour to about 4 hours, about 1.5 hours to about 3 hours, or about 2 hours, In some embodiments, the lignin may be contacted with the reagent for about two hours at about 30° C. Specific examples of contact time include about 1 hour, about 1.5 hours, about 2 hours, about 2.5 hours, about 3 hours, about 4 hours, about 5 hours, and ranges between any two of these values (for example, from about 2.5 hours to about 4 hours),

In further embodiments, the lignin/reagent reaction mixture may be refluxed for about 30 minutes to about 120 minutes, about 40 minutes to about 100 minutes, or about 60 minutes to about 80 minutes. In some embodiments, the lignin/reagent reaction mixture may be refluxed (Or about 1 hour. Specific examples of reflux time include about 1 hour, about 1.5 hours, about 2 hours, and ranges between any two of these values (for example, from about 1.5 hours to about 2 hours). In some embodiments, the lignmireauent reaction mixture may be neutralized with a basic solution. In some embodiments, the basic solution may be sodium hydroxide or calcium hydroxide at about 2% to about 20% by ⁻weight, about 5% to about 20% by weight, or about 0% to about 20% by weight.

In some embodiments where the reagent comprises at least one carboxylic acid compound, the concrete additive may be a liguin carboxylate compound. In some embodiments, the carboxylic acid compound may comprise at least one polycarboxylic acid, a hydroxycarboxylic acid, hydroxydicarboxylic acid, polyhydroxycarboxylic acid, or combinations thereof. In other embodiments, the carboxylic acid compound may comprise gluconic acid, citric acid, tartaric acid, hydroxybutyric acid, hydroxyacetic acid, hydroxymalonic acid, hydroxysuccinic acid, hydroxyglutamic acid, or combinations thereof. In some embodiments where the reagent comprises a hydroxyamine compound, the concrete additive may comprise a lignoethanolamine compound. In some embodiments, the hydroxylamine compound may comprise monoethanolainine, diethanolamine, triethanolamine, hydroxyl amine, or combinations thereof. In some embodiments where the reagent comprises an isoeyame terminated polymer, the concrete additive may comprise a lignourethane compound as a foamed hydrogel water stop product. In some embodiments where the reagent comprises an amine compound, the concrete additive may comprise a lignoamine compound. In some embodiments where the reagent comprises a phosphate compound, the concrete additive may comprise a lignophosphate compound. In some embodiments where the reagent comprises epichlorohydrine, the concrete additive may comprise a water based lignoepoxy compound. In some embodiments where the reagent comprises sodium bisulphite, the concrete additive may comprise a lignosulphonate compound with a high degree of sulphonation.

In another embodiment, a method of preparing Ignocarhoxykue or lignosulphonate carboxylate may comprise contacting lignin or lignosulphonate with carbon dioxide to produce lignocarboxylate or lignosulphonate carboxylate. In some embodiments, the carbon dioxide may be a gas or in the form of dry ice. In other embodiments, the carbon dioxide may be carbon dioxide adducts formed by carbon dioxide absorbers which are formed in the reclaiming processes of carbon dioxide from the atmosphere or from industrial sources. In some embodiments, the lignin may comprise black liquor and the lignosulphonate may be in the form of spent pulp liquor, sulphonated black liquor, or a combination thereof in some embodiments, the solid content of the black liquor, spent pulp liquor or sulphonated black liquor may be adjusted to may be adjusted to about 40% to about 70% by weight, to about 45% to about 65% by weight, or to about 50% to about t0% by weight prior to contacting the lignin or lignosulphonate with carbon dioxide. Specific examples of solid content include about 40%, about 45%, about 50%, about 55%, about 60%, about 65%. about 70%, and ranges between any two of these values (for example, from about 55% to about 65%).

In some embodiments, the lignin or lignosulphonate may be contacted with the carbon dioxide under a pressure of about 90 atm to about 150 atm, about 100 atm to about 130 atm, or about 100 atm to about .120 atm. In some embodiments, the lignin or lignosulphonate may be contacted with the carbon dioxide under a pressure of about 100 atm. In some embodiments, the lignin or lignosulphonate may be contacted with the carbon dioxide at a temperature of about 100° C. to about 160° C., about 1.10° C. to about 140° C., or about 120° C. to about 130° C. In some embodiments, the lignin or lignosulphonate may be contacted with the carbon dioxide at a temperature of about 125° C. Specific examples of temperatures include about 100° C., about 115° C., about 120° C., about 125° C., about 1313° C., about 140° C., about 150° C., about 160° C. and ranges between any two of these values (for example, from about 120° C. to about 140° C.). In some embodiments, the lignin or lignosulphonate may be contacted with the carbon dioxide for about 2 hours to about 8 hours, about 3 hours to about 7 hours, or about 4 hours to about 6 hours. In some embodiments, the lignin or lignosulphonate may be contacted with the carbon dioxide for about 5 hours. Specific examples of contact time include about 2 hours, about 3 hours, about 4 hours, about 4,5 hours, about 5 hours about 5.5 hours, about 6 hours, about 7 hours, about 8 hours, and ranges between any two of these values (for example, from about 4.5 hours to about 5.5 hours). In some embodiments, the contacting may take place in an autoclave with a rotating mix.

In an embodiment, a concrete additive comprises a lignophosphate compound, a lignosulphonate phosphate compound, a lignoethanolamine compound, a. lignosulphonate ethanolamine compound, a livalopolyhydroxycarboxylate compound, a litniosuiphonate polyhydroxycarboxylate compound, a lignopolvcarboxylate compound, a lignos tilphonate polycarboxylate compound, as lignohydroxycarboxylate compound, a lignosulphonate hydroxycarboxylate compound, or combinations thereof In some embodiments, the concrete additive may comprise to lignocarboxylate, as lignosulphonate carboxylate, to sodium lignocarboxylate, a sodium lignosulphonate carboxtrate, as sodium lignoacetate, a sodium lignosulphonate acetate, a sodium lignotartrate, a sodium lignosulphonate tartrate, a sodium litmobutyrate, a sodium lignosulphonate butyrate, a. sodium lignogluconate, a sodium lignosulphonate gluconate, or combinations thereof

In another embodiment, a water-based epoxy resin comprises a lignoepoxide compound or a lignosulphonate epoxide compound. In other embodiments, a polyurethane product comprises a lignourethane compound or a lignosulphonate urethane compound. In further embodiments, a corrosion inhibitor, epoxy hardener, or a base for a hydrogel comprises a lignoamine compound or a lignosulphonate amine compound.

### EXAMPLES

### Example 1

### Conversion of Black Liquor-Sourced Lignin to Methylol Lignin

Black liquor (1 L) with 50% to 60% solid content and a pH range of 9 to 13 was treated with varying amounts (100, 200, 400, 600, and 800 ml.) of a formaldehyde solution (36% to 38% formaldehyde content [wt./vol]) to achieve lignin:formaldehyde net ratios of 20:1, 10:1, 5:1, 3,6:1, and 2.5:1. Each reaction was carried out in a five necked flanged top reaction vessel fitted with efficient mechanical stirrer immersed in thermo stated water bath. The effects of reaction pH, temperature, time, and reactant ratio on the concentration of methylols formed were investigated. The concentration of methylol lianin was determined in the reaction mixture by colorimetric techniques using ceric ammonium nitrate and differential scanning calorimetry. Among the tested parameters, a reaction time of 3 hours with a pH of 10, a temperature of 65-70° C., and a lignin:formaldehyde net active content ratio of 5:1 gave the highest concentration of limo methylol derivatives. The obtained lignin methylol derivatives could be used in situ or separated from the solution and stabilized.

TABLE 1-1
Effect of weight ratio of lignin:aldehyde on the number of methylol groups
per structural unit of lignin as determined by colorimetric and DSC.

| | | | | | Increase CH₂OH/ | | |
|---|---|---|---|---|---|---|---|
| | Wt. ratio | Temperature | Reaction | | Structural unit | Average | Increase Number |
| Exp. | Lignin:aldehyde | ° C. | time (h) | pH | of lignin. | of 3 exp | of CH₂OH |
| C-1 to C-3 | 20:1 | 65-70 | 3.0 | 9-10 | 0.25-0.75 | 0.56 | 1.0 |
| C-4 to C-6 | 10:1 | 65-70 | 3.0 | 9-10 | 1.54-1.87 | 1.75 | 2.0 |
| C-7 to C-9 | 5:1 | 65-70 | 3,0 | 9-10 | 2.59-3.4 | 2.83 | 3.0 |
| C-10 to C-12 | 3.6:1* | 65-70 | 3,0 | 9-10 | 2.84-3.3 | 2.86 | 3.0 |
| C-13 to C-15 | 2.5:1* | 65-70 | 3.0 | 9-10 | 2.94-3.4 | 2.98 | 3.0 |

*Excess of unreacted formaldehyde was found in the reaction mixture

TABLE 1-2
Effect of reaction temperature on the number of methylol groups per
structural unit of lignin at weight ratio of lignin:aldehyde = 5:1.

| | | | | Increase CH₂OH/ | | |
|---|---|---|---|---|---|---|
| | Temp | Reaction | | Structural unit | Average | Increase Number |
| Exp. | ° C. | Time (h) | pH | of lignin | of 3 exp | of CH₂OH |
| T-1 to T-3 | 50-60 | 3.0 | 9-10 | 0.32-0.67 | 0.51 | 1.0 |
| T-4 to T-6 | 60-65 | 3.0 | 9-10 | 2.33-2.57 | 2.48 | 3.0 |
| T-7 to T-9 | 65-70 | 3,0 | 9-10 | 2.89-3.4 | 2.93 | 3.0 |
| T-10 to T-12 | 70-75 | 3.0 | 9-10 | 2.44-2.94 | 2.54 | 3.0 |
| T-13 to T-15 | 75-80* | 3.0 | 9-10 | 1.74-2.14 | 1.87 | 2.0 |

*Temperatures above 80° C. gave crosslinked products even for lower reaction time.

TABLE 1-3
Effect of pH on the methylol groups per structural
unit of lignin at weight ratio of lignin:aldehyde =
5:1 and reaction temperature = 65-70° C.

| | | | Increase | | |
|---|---|---|---|---|---|
| | Reac- | | CH₂OH/Struc- | | Increase |
| | tion | | tural unit | Average | number |
| Exp. | time (h) | pH | of lignin. | of 3 exp | of CH₂OH |
| Al-1 to Al-3 | 3.0 | 8-9 | 0.22-0.48 | 0.45 | — |
| Al-4 to Al-6 | 3.0 | 9-10 | 2.89-3.4 | 2.93 | 3.0 |
| Al-7 to Al-9 | 3.0 | 10-11 | 2.78-3.32 | 2.90 | 3.0 |
| Al-10 to Al-12 | 3.0 | 11-12 | 2.01-2.64 | 2.54 | 3.0 |
| Al-13 to Al-15* | 3.0 | 12-13 | 1.64-1.98 | 1.87 | 2.0 |

*pH 13 and above gave gel crosslinked products even for lower reaction time.

TABLE 1-4
Effect of reaction time on the number of methylol groups per
structural unit of lignin at weight ratio of lignin:aldehyde =
5:1, pH = 9-10, and reaction temperature = 65-70° C.

| | | Increase CH₂OH/ | | Increase |
|---|---|---|---|---|
| | Reaction | Structural unit | Average | number |
| Exp. | time (h) | of lignin. | of 3 exp | of CH₂OH |
| t-1 to t-3 | 2.5 | 1.80-2.48 | 2.03 | 2 |
| t-4 to t-6 | 3.0 | 2.89-3.4 | 2.93 | 3.0 |
| t -7 to t-9 | 3.5 | 2.92-3.12 | 2.97 | 3.0 |
| t -10 to t-12 | 4.0 | 2.85-3.10 | 2.90 | 3.0 |
| t-13 to t 15 | 5.0 | 2.65-2.86 | 2.79 | 3.0 |

*Reaction time above 5 hours gave crosslinked gel products.

### Example 2

### Purification and Stabilization of Lignin Methylol

The lignin methylol reaction products from Example 1 in each case were cooled to 0-5° C. and neutralized to pH 7 by adding a pre-cooled 10% phosphoric acid (at 5° C.). The viscous semi-solid lignin methylol products were separated from the aqueous solution, dissolved in ethanol, dried with molecular sieves, and either used directly after evaporating ethanol under reduced pressure or stabilized by alcohols for storage in a refriuerator for future use.

### Example 3

### Preparation and Separation of Methylol Lignin from Solid Lignin Waste

Solid lignin (500 grams) from pulping waste was dissolved in 10-20% sodium hydroxide solution, the pH was adjusted to 9-10, with 50% to 60% solid content, and the solution was treated with formaldehyde at ligninformaldehyde net ratios of 20:1, 10:1, 5:1, 3.6:1, and 2.5:1. A reaction time of 3 hours with a pH of 10, as temperature of 60-75° C., and a lignin:formaldehyde net active content ratio of 5:1 gave 2.8 methylol groups per lignin structural unit. (Typical values are shown in Tables 1-1 to 1-4).

### Example 4

### Preparation of Methylol Lignosulphonate Derivatives

Lignosulphonate pulping by product was adjusted to a pH of 10 with 50% to 60% solid content and was treated. with varying amounts of a formaldehyde solution to achieve lignin:formaldehyde net ratios of 20:1, 10:1, 5:1, 3,6:1, and 2.5:1.

### Example 5

### Preparation of Sodium Lignocarboxylate

One mole of a methylol lignin solution as prepared in Examples 1 or 2 was treated with citric, acid at 30° C. using equivalent moles to methylol groups with mixing for two hours. The reaction mixture was then refluxed for one hour, cooled, and neutralized with a 20% sodium hydroxide solution to obtain sodium lignocarboxylate.

### Example 6

### Preparation of Sodium Iionocarboxylatesulgluconate

One mole of methylol ligno sulphonate as prepared in Example 4 was treated with citric acid at 30° C. using equivalent moles to methylol groups with mixing for two hours. The reaction mixture was then refluxed for one hour, cooled, and neutralised with 20% sodium hydroxide solution to obtain sodium lignocarboxylatesulphonate dual functionality concrete admixture.

### Example 7

### Preparation of Sodium Lignogluconate

One mole of a methylol lignin solution as prepared in Examples I, or 2 was treated with sodium gluconate or glonic acid at 30 πC. using equivalent moles to methylol groups. When sodium gluconate was used as 10% gluconic acid as catalyst and co reactant was added to the reaction mixture. The reaction mixture was mixed for two hours, and was then refluxed for one hour, cooled, and neutralized with 20% sodium hydroxide solution to obtain sodium lignogluconate concrete admixture.

### Example 8

### Preparation of Sodium Lignosulphonate Gluuconate

One mole of a methylol lignosulphonate solution as prepared in Example 4 was treated with sodium gluconate or gluconic acid at 30° C using equivalent moles to methylol groups. When sodium gluconate was used as reactant, 10% gluconic acid as catalyst and co reactant was added to the reaction mixture. The reaction mixture was mixed for two hours, and was then refluxed for one hour, cooled, and neutralized with 20% sodium hydroxide solution to obtain sodium lignosulphonate gluconate as concrete admixture.

### Example 9

### Preparation of Lignocarboxylate from Black Liquor and Carbon Dioxide

An autoclave reactor was charged with black liquor and solid carbon dioxide (dry ice), and was then secured and heated to 125° C. at 100 atm pressure with mixing for five hours. The reaction mixture was cooled and then the degree of carboxylation was determined by FTIR spectroscopy carried out on a purified sample. The quantitative analyses were based on the peak height at 1750 cm⁻¹ related to carboxyl group. The product underwent carboxylation as demonstrated by a 2-5 increase in the solid content after the carboxylation reactions which was in a good agreement with the FTUR results.

The present disclosure is not to be limited in terms of the particular embodiments described, in this application, which are intended as illustrations of various aspects. Many modifications and variations can be made without departing, from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled, it is to be understood that this disclosure is not limited to particular methods, reagents, compounds, compositions or biological systems, which can, of course, vary. It is also to be understood that the terminology used herein is for the purpose of describing particular embodiments only, and is not intended to be limiting, 100501 With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc:), It will be further understood by those within the at that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and ‘one or more” to introduce claim recitations however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an’ (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted, to mean at least the recited number (e.g., the bare recitation of “two recitations,” without other modifiers, means at least two recitations, or two or more recitations). Furthermore, in those instances Where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or figure, should be understood to contemplate the possibilities of including one of the terms, either of the terms, or both terms. For example, the phrase “A or B” will be understood to include the possibilities of “A” or “B” or “A and B,”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass an and all possible subranges and combinations of subranges thereof. Any listed range can be easily recognized as sufficiently describing and enabling the same range being broken down into at least equal halves, thirds, quarters, fifths, tenths, etc. As a nonlimiting example, each range discussed herein can be readily broken down into a lower third, middle third and upper third, etc. As will also be understood by one skilled in the art all language such as “up to,” “at least,” and the like include the number recited and refer to manes which can be subsequently broken down into subranges as discussed above. Finally, as will he understood by one skilled in the art, a range includes each individual member. Thus, for example, a group having 1-3 substituents refers to groups having 1, 2, or 3 substituents. Similarly, a group having 1-5 substituents refers to groups having 1, 2, 3, 4, or 5 substituents, and so forth.

1. A method of preparing a lignosulphonate methylol, the method comprising contacting lignosulphonate with an aldehyde compound to produce the lignosulphonate methylol; cooling the lignosulphonate methylol; and isolating the lignosulphonate methylol.

2. The method of claim 1, wherein the lignosulphonate is in the form of spent pulp liquor, sulphonated black liquor, or a combination thereof.

3. The method of claim 2, wherein the solid content of the spent pulp liquor or sulphonated black liquor is adjusted to about 50% to about 60% by weight prior to contacting the lignosulphonate with the aldehyde compound.

4.-12. (canceled)

13. The method of claim 1, wherein the lignosulphonate methylol is lignosulphonate monomethylol, lignosulphonate dimethylol, lignosulphonate trimethylol, or lignosulphonate oligomethylol.

14. The method claim 1, wherein cooling is to about 0° C. to about 10° C.

15. The method of claim 14, further comprising neutralizing the cooled lignosulphonate methylol with a pre-cooled acid, which is at about 0° C. to about 10° C. and is about 5% to about 10% acid by weight.

16. (canceled)

17. The method of claim 15, further comprising dissolving the isolated lignosulphonate methylol in at least one alcohol.

18. The method of claim 17, further comprising drying the lignosulphonate methylol.

19. The method of claim 18, further comprising evaporating the alcohol under reduced pressure to produce the lignosulphonate methylol as a solid or semisolid residue.

20.-21. (canceled)

22. The method of claim 15, wherein the cooled lignosulphonate methylol is neutralized to a pH of about 7.

23. The method of claim 15, wherein the pre-cooled acid is phosphoric acid, paratoluenesulphonic acid, or a hydroxycarboxylic acid.

24. The method of claim 17, wherein the alcohol is selected from ethanol, methylated spirits and isobutanol.

25. The method of claim 18, wherein the lignosulphonate methylol is dried with molecular sieves.

26.-49. (canceled)

50. A method of preparing lignin methylol or lignosulphonate methylol from solid lignin or solid lignosulphonate, the method comprising: dissolving the lignin or lignosulphonate in a base solution; and contacting the dissolved lignin or lignosulphonate with an aldehyde compound to produce the lignin methylol or lignosulphonate methylol; and isolating the lignin methylol or lignosulphonate methylol.

51. The method of claim 50, wherein the lignin or lignosulphonate is in the form of spent pulp liquor, sulphonated black liquor, black liquor, or a combination thereof.

52. (canceled)

53. The method of claim 50, wherein the base solution is about 10% to about 20% sodium hydroxide or calcium hydroxide by weight.

54. The method of claim 50, wherein the solid content of the spent pulp liquor or sulphonated black liquor is adjusted to about 50% to about 60% by weight prior to reacting the lignosulphonate with the aldehyde compound.

55.-63. (canceled)

64. The method of claim 50, wherein the lignosulphonate methylol is lignosulphonate monomethylol, lignosulphonate dimethylol, lignosulphonate trimethylol, or lignosulphonate oligomethylol, and the lignin methylol is lignin monomethylol, lignin dimethylol, lignin trimethylol, or lignin oligomethylol.

65. The method of claim 50, further comprising cooling the lignin methylol or lignosulphonate methylol to about 0° C. to about 5° C.

66. The method of claim 65, further comprising neutralizing the cooled lignin methylol or lignosulphonate methylol with a pre-cooled acid, which is at about 0° C. to about 10° C. and is about 5% to about 10% acid by weight.

67. (canceled)

68. The method of claim 66, further comprising dissolving the separated lignin methylol or lignosulphonate methylol in an alcohol.

69. The method of claim 68, further comprising drying the lignin methylol or lignosulphonate methylol.

70. The method of claim 69, further comprising evaporating the alcohol under reduced pressure to produce the lignin methylol or lignosulphonate methylol as a solid residue.

71.-72. (canceled)

73. The method of claim 66, wherein the cooled lignin methylol or lignosulphonate methylol is neutralized to a pH of about 7.

74. (canceled)

75. The method of claim 68, wherein the alcohol is selected from ethanol and isobutanol.

76.-134. (canceled)
